(19) United States
(12) Patent Application Publication
(10) Pub. No.: US 2026/0113807 A1
(43) Pub. Date: Apr. 23, 2026

(54) Method, Apparatus and Computer Program

(71) Applicant: Nokia Technologies Oy, Espoo (FI)

(72) Inventors: Tao TAO, Shanghai (CN); Daniela LASELVA, Aalborg (DK); Mads LAURIDSEN, Aalborg (DK); Yan MENG, Shanghai (CN)

(21) Appl. No.: 19/189,968

(22) Filed: Apr. 25, 2025

Related U.S. Application Data
(63) Continuation of application No. 18/860,496.

(51) Int. Cl. H04W 76/28; H04W 24/10; H04W 72/231; H04W 74/04; H04W 74/0816

(52) U.S. Cl. CPC H04W 76/28; H04W 24/10; H04W 72/231; H04W 74/04; H04W 74/0816

(57) ABSTRACT

There is provided an apparatus for a terminal, wherein the apparatus has circuitry for receiving, from a network entity, an indication of a discontinuous transmission configuration associated with the network entity, wherein the indication indicates to the terminal that the network entity will refrain from providing downlink transmissions during a period time associated with the discontinuous transmission configuration. The apparatus also has circuitry for determining whether at least one of: a reception at the terminal, or a transmission from the terminal, will at least partially overlap with the time period associated with the discontinuous transmission configuration. The apparatus also has circuitry for, when it is determined that at least one of: the reception and the transmission will at least partially overlap with the time period, performing an action associated with the determined reception and/or transmission.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus for a terminal, the apparatus comprising: means for receiving, from a network entity, an indication of a discontinuous transmission configuration associated with the network entity, wherein the indication indicates to the terminal that the network entity will refrain from providing downlink transmissions during a time period associated with the discontinuous transmission configuration; means for determining whether at least one of: a reception at the terminal, and a transmission from the terminal, will at least partially overlap with the time period associated with the discontinuous transmission configuration; and means for, when it is determined that at least one of: the reception and the transmission will at least partially overlap with the time period, performing an action associated with the determined reception and/or transmission.

In examples, the discontinuous transmission configuration associated with the network entity is being used by the network entity, or is scheduled to be used by the network entity.

In examples, the discontinuous transmission configuration is a cell discontinuous transmission configuration.

In an example, the means for performing an action comprises means for applying a skipping of the determined reception and/or transmission, such that the terminal refrains from performing operations associated with the determined reception and/or transmission.

In examples, the skipping is applied to pre-configured search space set groups.

In an example, the means for performing an action comprises means for skipping measurements to be performed by the terminal, when the determined reception at the user equipment comprises at least one reference signal.

In an example, the means for performing an action comprises means for performing measurements on reference signal resource elements that do not overlap with the time period associated with the discontinuous transmission configuration.

In an example, the means for performing an action comprises means for postponing a reception and/or transmission operation associated with the determined reception and/or transmission.

In an example, the means for postponing comprises means for using the discontinuous transmission configuration to determine a time to postpone, such that there is not an overlap.

In an example, the means for performing an action comprises means for changing a timer associated with the determined reception and/or transmission.

In an example, the means for changing the timer comprises means for, at least one of: suspending the timer, ignoring an expired timer, and extending a timer.

In an example, the discontinuous transmission configuration comprises a resource pattern, in the time domain, wherein the resource pattern comprises at least one of: a pattern time duration, a time offset, a repetition period, and a micro-discontinuous transmission configuration.

In an example, the resource pattern comprises at least one of: information about the applicability of the resource pattern to one or more channels and/or signals, and operations to be performed by the terminal related to the one or more channels and/or signals.

In an example, the indication is received, via a broadcast signalling, to terminals in a cell, wherein the terminal is within coverage of the cell, the cell being provided by the network entity.

In an example, the apparatus is comprising: means for receiving a plurality of discontinuous transmission configurations associated with the network entity, wherein the discontinuous transmission configuration is one of the plurality of discontinuous transmission configurations.

In an example, the plurality of discontinuous transmission configurations is received via: radio resource signalling, a medium access control element, downlink control information, or system information.

In an example, the apparatus is comprising: means for receiving, from the network entity, an indication to activate the discontinuous transmission configuration.

In an example, the indication to activate is received via physical broadcast signalling.

In an example, the apparatus is comprising: wherein physical downlink shared channel aggregation is configured for the terminal by the network entity, means for determining whether a first redundant version of the determined reception is at least partially overlapped with the time period associated with the discontinuous transmission configuration; and means for, when is it determined that the first redundant version is at least partially overlapped, skipping the reception of all redundant versions associated with the determined reception.

In an example, the apparatus is comprising: wherein physical downlink shared channel aggregation is applied by the network entity, means for determining whether at least one redundant version other than the first redundant version of the determined reception is overlapped with the time period associated with the discontinuous transmission configuration; and means for, when is it determined that at least one redundant version other than the first redundant version is overlapped, adjusting an aggregation level associated with the determined reception.

In an example, the discontinuous transmission configuration comprises a micro-discontinuous transmission configuration.

In an example, the apparatus is comprising: means for receiving, from a network entity, a further indication of a discontinuous reception configuration associated with the terminal.

In an example, the apparatus is comprising: means for determining whether a transmission from the terminal, will at least partially overlap with a further time period associated with the discontinuous reception configuration; and means for, when it is determined that the transmission will at least partially overlap with the further time period, performing a further action associated with the determined reception and/or transmission.

According to an aspect, there is provided an apparatus for a network entity, the apparatus comprising: means for determining a discontinuous transmission configuration associated with the network entity; means for providing, to a terminal, an indication of the determined discontinuous transmission configuration associated with the network entity; and means for refraining from providing downlink transmissions to the terminal during a time period associated with the discontinuous transmission configuration.

In an example, the discontinuous transmission configuration associated with the network entity is: being used by the network entity, or is scheduled to be used by the network entity.

In an example, the means for refraining from providing downlink transmissions comprises means for postponing the downlink transmissions until the time period associated with the discontinuous transmission configuration has expired.

In an example, the discontinuous transmission configuration comprises a resource pattern, in the time domain, wherein the resource pattern comprises at least one of: a pattern time duration; a time offset; a repetition period; a micro-discontinuous transmission configuration.

In an example, the resource pattern comprises at least one of: information about the applicability of the resource pattern to one or more channels and/or signals, and operations to be performed by the terminal related to the one or more channels and/or signals.

In an example, the indication is provided, via a broadcast signalling, to terminals in a cell, wherein the terminal is within coverage of the cell, the cell being provided by the network entity.

In an example, the apparatus is comprising: means for providing a plurality of discontinuous transmission configurations associated with the network entity, wherein the discontinuous transmission configuration is one of the plurality of discontinuous transmission configurations.

In an example, the plurality of discontinuous transmission configurations is provided to the terminal via: radio resource signalling, a medium access control control element, downlink control information, or system information.

In an example, the apparatus is comprising: means for providing, to the terminal, an indication to activate the discontinuous transmission configuration.

In an example, the indication to activate the discontinuous transmission configuration is received via physical layer signalling.

In an example, the apparatus is comprising: means for providing, to the terminal, a further indication of a discontinuous reception configuration associated with the terminal.

In an example, the means comprises: at least one processor; and at least one memory including computer program code, the at least one memory and computer program code configured to, with the at least one processor, cause the performance of the apparatus.

According to an aspect, there is provided a method performed by a terminal, the method comprising: receiving, from a network entity, an indication of a discontinuous transmission configuration associated with the network entity, wherein the indication indicates to the terminal that the network entity will refrain from providing downlink transmissions during a time period associated with the discontinuous transmission configuration; determining whether at least one of: a reception at the terminal, and a transmission from the terminal, will at least partially overlap with the time period associated with the discontinuous transmission configuration; and when it is determined that at least one of: the reception and the transmission will at least partially overlap with the time period, performing an action associated with the determined reception and/or transmission.

In an example, the performing an action comprises applying a skipping of the determined reception and/or transmission, such that the terminal refrains from performing operations associated with the determined reception and/or transmission.

In an example, the performing an action comprises skipping measurements to be performed by the terminal, when the determined reception at the user equipment comprises at least one reference signal.

In an example, the performing an action comprises performing measurements on reference signal resource elements that do not overlap with the time period associated with the discontinuous transmission configuration.

In an example, the performing an action comprises postponing a reception and/or transmission operation associated with the determined reception and/or transmission.

In an example, the performing an action comprises changing a timer associated with the determined reception and/or transmission.

In an example, the changing the timer comprises, at least one of: suspending the timer, ignoring an expired timer, and extending a timer.

In an example, the discontinuous transmission configuration comprises a resource pattern, in the time domain, wherein the resource pattern comprises at least one of: a pattern time duration, a time offset, a repetition period, and a micro-discontinuous transmission configuration.

In an example, the resource pattern comprises at least one of: information about the applicability of the resource pattern to one or more channels and/or signals, and operations to be performed by the terminal related to the one or more channels and/or signals.

In an example, the indication is received, via a broadcast signalling, to terminals in a cell, wherein the terminal is within coverage of the cell, the cell being provided by the network entity.

In an example, the method comprises: receiving a plurality of discontinuous transmission configurations associated with the network entity, wherein the discontinuous transmission configuration is one of the plurality of discontinuous transmission configurations.

In an example, the plurality of discontinuous transmission configurations is received via: radio resource signalling, a medium access control control element, downlink control information, or system information.

In an example, the method comprises: receiving, from the network entity, an indication to activate the discontinuous transmission configuration.

In an example, the method comprises: wherein physical downlink shared channel aggregation is configured for the terminal by the network entity, determining whether a first redundant version of the determined reception is at least partially overlapped with the time period associated with the discontinuous transmission configuration; and when is it determined that the first redundant version is at least partially overlapped, skipping the reception of all redundant versions associated with the determined reception.

In an example, the method comprises: wherein physical downlink shared channel aggregation is applied by the network entity, determining whether at least one redundant version other than the first redundant version of the determined reception is overlapped with the time period associated with the discontinuous transmission configuration; and when is it determined that at least one redundant version other than the first redundant version is overlapped, adjusting an aggregation level associated with the determined reception.

In an example, the method comprises: receiving, from a network entity, a further indication of a discontinuous reception configuration associated with the terminal.

In an example, the method comprises: determining whether a transmission from the terminal, will at least partially overlap with a further time period associated with the discontinuous reception configuration; and when it is determined that the transmission will at least partially overlap with the further time period, performing a further action associated with the determined reception and/or transmission.

According to an aspect, there is provided a method performed by a network entity, the method comprising: determining a discontinuous transmission configuration associated with the network entity; providing, to a terminal, an indication of the determined discontinuous transmission configuration associated with the network entity; and refraining from providing downlink transmissions to the terminal during a time period associated with the discontinuous transmission configuration.

In an example, the discontinuous transmission configuration associated with the network entity is: being used by the network entity, or is scheduled to be used by the network entity.

In an example, the refraining from providing downlink transmissions comprises postponing the downlink transmissions until the time period associated with the discontinuous transmission configuration has expired.

In an example, the discontinuous transmission configuration comprises a resource pattern, in the time domain, wherein the resource pattern comprises at least one of: a pattern time duration; a time offset; a repetition period; a micro-discontinuous transmission configuration.

In an example, the resource pattern comprises at least one of: information about the applicability of the resource pattern to one or more channels and/or signals, and operations to be performed by the terminal related to the one or more channels and/or signals.

In an example, the indication is provided, via a broadcast signalling, to terminals in a cell, wherein the terminal is within coverage of the cell, the cell being provided by the network entity.

In an example, the method comprises: providing a plurality of discontinuous transmission configurations associated with the network entity, wherein the discontinuous transmission configuration is one of the plurality of discontinuous transmission configurations.

In an example, the plurality of discontinuous transmission configurations is provided to the terminal via: radio resource signalling, a medium access control control element, downlink control information, or system information.

In an example, the method comprises: providing, to the terminal, an indication to activate the discontinuous transmission configuration.

In an example, the indication to activate the discontinuous transmission configuration is received via physical layer signalling.

In an example, the method comprises: providing, to the terminal, a further indication of a discontinuous reception configuration associated with the terminal.

According to an aspect, there is provided an apparatus comprising: one or more processors, and memory storing instructions that, when executed by the one or more processors, cause the apparatus to perform: receiving, from a network entity, an indication of a discontinuous transmission configuration associated with the network entity, wherein the indication indicates to the terminal that the network entity will refrain from providing downlink transmissions during a time period associated with the discontinuous transmission configuration; determining whether at least one of: a reception at the terminal, and a transmission from the terminal, will at least partially overlap with the time period associated with the discontinuous transmission configuration; and when it is determined that at least one of: the reception and the transmission will at least partially overlap with the time period, performing an action associated with the determined reception and/or transmission.

In an example, the performing an action comprises applying a skipping of the determined reception and/or transmission, such that the terminal refrains from performing operations associated with the determined reception and/or transmission.

In an example, the performing an action comprises skipping measurements to be performed by the terminal, when the determined reception at the user equipment comprises at least one reference signal.

In an example, the performing an action comprises performing measurements on reference signal resource elements that do not overlap with the time period associated with the discontinuous transmission configuration.

In an example, the performing an action comprises postponing a reception and/or transmission operation associated with the determined reception and/or transmission.

In an example, the performing an action comprises changing a timer associated with the determined reception and/or transmission.

In an example, the changing the timer comprises, at least one of: suspending the timer, ignoring an expired timer, and extending a timer.

In an example, the discontinuous transmission configuration comprises a resource pattern, in the time domain, wherein the resource pattern comprises at least one of: a pattern time duration, a time offset, a repetition period, and a micro-discontinuous transmission configuration.

In an example, the resource pattern comprises at least one of: information about the applicability of the resource pattern to one or more channels and/or signals, and operations to be performed by the terminal related to the one or more channels and/or signals.

In an example, the indication is received, via a broadcast signalling, to terminals in a cell, wherein the terminal is within coverage of the cell, the cell being provided by the network entity.

In an example, the apparatus caused to perform: receiving a plurality of discontinuous transmission configurations associated with the network entity, wherein the discontinuous transmission configuration is one of the plurality of discontinuous transmission configurations.

In an example, the plurality of discontinuous transmission configurations is received via: radio resource signalling, a medium access control control element, downlink control information, or system information.

In an example, the apparatus caused to perform: receiving, from the network entity, an indication to activate the discontinuous transmission configuration.

In an example, the apparatus caused to perform: wherein physical downlink shared channel aggregation is configured for the terminal by the network entity, determining whether a first redundant version of the determined reception is at least partially overlapped with the time period associated with the discontinuous transmission configuration; and when is it determined that the first redundant version is at least partially overlapped, skipping the reception of all redundant versions associated with the determined reception.

In an example, the apparatus caused to perform: wherein physical downlink shared channel aggregation is applied by the network entity, determining whether at least one redundant version other than the first redundant version of the determined reception is overlapped with the time period associated with the discontinuous transmission configuration; and when is it determined that at least one redundant version other than the first redundant version is overlapped, adjusting an aggregation level associated with the determined reception.

In an example, the apparatus caused to perform: receiving, from a network entity, a further indication of a discontinuous reception configuration associated with the terminal.

In an example, the apparatus caused to perform: determining whether a transmission from the terminal, will at least partially overlap with a further time period associated with the discontinuous reception configuration; and when it is determined that the transmission will at least partially overlap with the further time period, performing a further action associated with the determined reception and/or transmission.

According to an aspect, there is provided an apparatus comprising: one or more processors, and memory storing instructions that, when executed by the one or more processors, cause the apparatus to perform: determining a discontinuous transmission configuration associated with the network entity; providing, to a terminal, an indication of the determined discontinuous transmission configuration associated with the network entity; and refraining from providing downlink transmissions to the terminal during a time period associated with the discontinuous transmission configuration.

In an example, the discontinuous transmission configuration associated with the network entity is: being used by the network entity, or is scheduled to be used by the network entity.

In an example, the refraining from providing downlink transmissions comprises postponing the downlink transmissions until the time period associated with the discontinuous transmission configuration has expired.

In an example, the discontinuous transmission configuration comprises a resource pattern, in the time domain, wherein the resource pattern comprises at least one of: a pattern time duration; a time offset; a repetition period; a micro-discontinuous transmission configuration.

In an example, the resource pattern comprises at least one of: information about the applicability of the resource pattern to one or more channels and/or signals, and operations to be performed by the terminal related to the one or more channels and/or signals.

In an example, the indication is provided, via a broadcast signalling, to terminals in a cell, wherein the terminal is within coverage of the cell, the cell being provided by the network entity.

In an example, the apparatus caused to perform: providing a plurality of discontinuous transmission configurations associated with the network entity, wherein the discontinuous transmission configuration is one of the plurality of dis continuous transmission configurations.

In an example, the plurality of discontinuous transmission configurations is provided to the terminal via: radio resource signalling, a medium access control control element, downlink control information, or system information.

In an example, the apparatus caused to perform: providing, to the terminal, an indication to activate the discontinuous transmission configuration.

In an example, the indication to activate the discontinuous transmission configuration is received via physical layer signalling.

In an example, the apparatus caused to perform: providing, to the terminal, a further indication of a discontinuous reception configuration associated with the terminal.

According to an aspect, there is provided a computer program comprising computer executable instructions which when run on one or more processors perform: receiving, from a network entity, an indication of a discontinuous transmission configuration associated with the network entity, wherein the indication indicates to the terminal that the network entity will refrain from providing downlink transmissions during a time period associated with the discontinuous transmission configuration; determining whether at least one of: a reception at the terminal, and a transmission from the terminal, will at least partially overlap with the time period associated with the discontinuous transmission configuration; and when it is determined that at least one of: the reception and the transmission will at least partially overlap with the time period, performing an action associated with the determined reception and/or transmission.

According to an aspect, there is provided a computer program comprising computer executable instructions which when run on one or more processors perform: determining a discontinuous transmission configuration associated with the network entity; providing, to a terminal, an indication of the determined discontinuous transmission configuration associated with the network entity; and refraining from providing downlink transmissions to the terminal during a time period associated with the discontinuous transmission configuration.

A computer product stored on a medium may cause an apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations

AF Application Function
AMF: Access Management Function
AN: Access Network
BS Base Station
CN: Core Network
DL: Downlink
DTX: Discontinuous Transmission
eNB: eNodeB
GC-PDCCH: Group Common Physical Downlink Control Channel
gNB: gNodeB
IIoT: Industrial Internet of Things
LTE: Long Term Evolution
NDI: New Data Indication
NEF: Network Exposure Function
NG-RAN: Next Generation Radio Access Network
NF: Network Function
NR: New Radio
NRF: Network Repository Function
NW: Network
MS: Mobile Station
PCF Policy Control Function
PDCCH: Physical Downlink Control Channel
PDSCH: Physical Downlink Shared Channel
PLMN: Public Land Mobile Network
RAN: Radio Access Network
RF Radio Frequency
RS: Reference Signal
RV: Redundant Version
SMF: Session Management Function
SPS: Semi Persistent Scheduling
UE: User Equipment
UDR: Unified Data Repository
UDM: Unified Data Management
UL: Uplink
UPF: User Plane Function
3GPP: 3^{rd} Generation Partnership Project
5G: 5^{th} Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows an example signalling diagram between a terminal and a network entity;

FIG. 5 shows a schematic example of aggregation level adjustment for a physical downlink shared channel;

FIG. 6 shows an example method flow diagram performed by a terminal;

FIG. 7 shows an example method flow diagram performed by a network entity; and

FIG. 8 shows a schematic representation of a non-volatile memory medium storing instructions which when executed by a processor allow a processor to perform one or more of the steps of the method of FIGS. 6 and 7.

### DETAILED DESCRIPTION

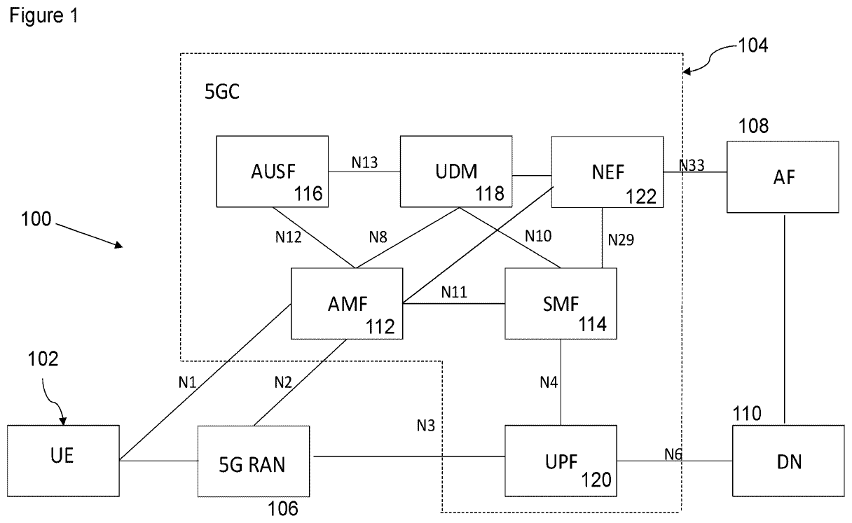

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of disclose, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprises a device 102 such as user equipment or terminal, a 5G access network (5G-AN) 106, a 5G core network (5GC) 104, one or more network functions (NF), one or more application function (AF) 108 and one or more data networks (DN) 110.

The 5G-AN 106 may comprise one or more gNodeB (gNB) distributed unit functions connected to one or more gNodeB (gNB) centralized unit functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 4G, 3G and other 3GPP standards.

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a station or access point, and transmit and/or receive communications on the carrier.

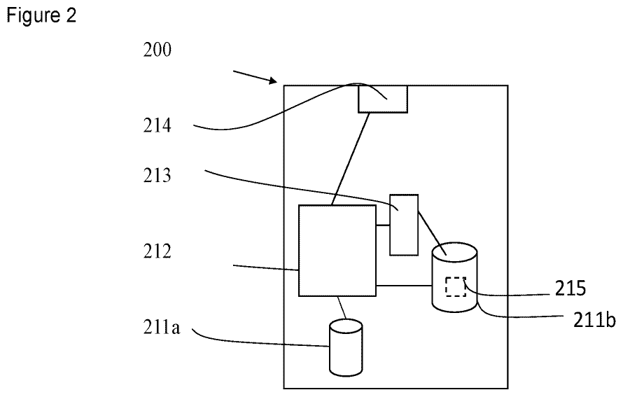

FIG. 2 illustrates an example of a control apparatus 200 for controlling a function of the 5G-AN or the 5GC as illustrated on FIG. 1. The control apparatus 200 may control a network entity. The network entity may be, for example, a base station (gNB). The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

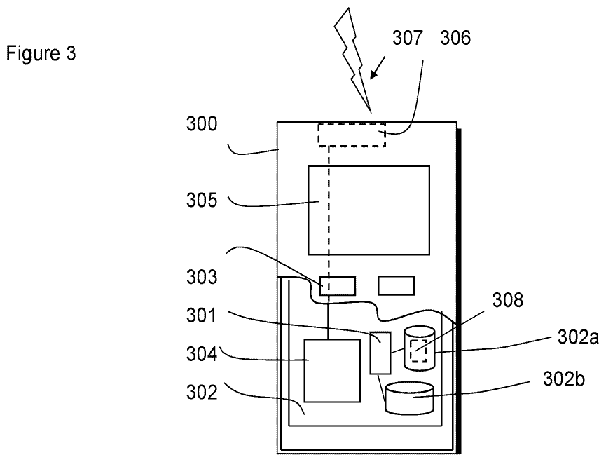

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

In current mobile networks, base stations are responsible for large percentage of the total carbon emissions of mobile networks. Improving the efficiency of the energy usage of base stations will therefore have a positive effect on the carbon footprint made by mobile networks. Techniques performed by base station, such as sleep modes, may reduce the energy used by base stations. Base stations can be switched off/put into sleep mode for longer periods of time, e.g. for one or more minutes. However, this has the drawback that there will be a restart delay when the base station wakes up. Another technique is discontinuous transmission (DTX) whereby a base station switches to a sleep mode for very short periods of time (micro-sleep), e.g., for a few milliseconds. During these DTX time periods of sleep, one or more elements of the radio frequency chain are switched-off. In the case of DTX, the power and resource allocations are made in such a manner that some resource elements (subframes) can be freed up, and the base station then switches to micro-sleep mode in order to save energy.

DTX may be performed by terminals/user equipments (UEs). In this case, DTX is a means by which a UE is temporarily shut off or muted while the UE lacks a voice input, for example. To differentiate between DTX performed by UEs, the DTX at the network side may be referred to as cell DTX.

Along with hardware and software capability improvement using DTX at base stations, the temporary shutdown of the power amplifiers (PA) on an orthogonal frequency division multiplexing (OFDM) symbol basis becomes possible. The temporary shutdown is commonly applied in commercial networks. In following examples, an OFDM symbol level discontinuous-transmission is referred to as micro DTX (μDTX).

On or more of the following examples are related to DTX and/or micro-DTX.

In a mobile communications network, when the cell load is low, a cell may want to apply DTX and/or μDTX as much as possible when there is no user plane data to be transmitted in a slot, in order to reduce energy/resource usage. However, some pre-configured transmissions from the base station to UEs in the cell may interrupt a cell DTX “sleep” time period. Examples of pre-configured transmissions include periodic channel state information-reference signals (CSI-RS), and downlink semi-persistent scheduling (DL SPS) transmissions. If these transmissions are not urgent, a base station may be able to skip the transmissions, or delay them, in order to save energy.

One or more of the examples discussed below aim to improve network efficiency, by using less energy and resources at the network, through the use of DTX.

In examples, there is provided a mechanism to use downlink DTX and/or μDTX operation that minimises the impact on UEs and base stations (gNBs). The mechanism comprises two features. Firstly, an operation to indicate the DTX/μDTX configuration being used by the base station to one or more UEs. Secondly, a way to alter the behaviours of the UE/operations performed by the UE, when indicated DTX/μDTX periods collide with receptions or transmissions of data at the UE. The examples discussed related to μDTX are equally applicable for DTX, and vice-versa.

As part of the first step, in order to provide a DTX/μDTX occasion indication to UEs, radio resource control (RRC) signalling may be used for configuring certain time patterns. Furthermore, physical layer signalling (PHY) may be used to activate or deactivate one of the DTX/μDTX configurations sent via RRC. In examples, a plurality of DTX/μDTX configurations are provided to a UE via (dedicated or common) RRC signalling.

Each DTX/μDTX configuration may include a time domain resource pattern. Each time domain resource pattern may include, for example, at least one of: a pattern time duration (on/off time duration), an offset, a repetition period. Each DTX/μDTX configuration may include information about the applicability of the pattern to certain channels/signals and/or associated UE operations on those channels/signals. For example, a DTX on/off time pattern duration indicates that the first 5 ms of every 20 ms is an off/sleep period. Further, this pattern is applicable to DL SPS transmissions (only). In this case, the UE operation during the 5 ms ‘off’ will be skipping/dropping all DL SPS PDSCHs. As this DTX pattern is applicable to DL SPS, the UE may still receive other information on other channels with this DTX pattern.

In examples, the base station uses PHY broadcast signalling to indicate to the UE which DTX/μDTX configuration is to be used. An example using broadcast signalling uses a group-common physical downlink control channel (GC-PDCCH). The signalling may also contain information of a duration time of the indicated DTX/μDTX configuration. The duration time means the time from when the base station starts to apply DTX/μDTX until the base station stops using the configuration. In other examples, the base station may provide further signalling (e.g. further GC-PDCCH) to the UE deactivate an active DTX/μDTX configuration.

As part of the second step, the behaviour of the UE is changed according to the indicated DTX/μDTX configuration. In examples, the default UE behaviour/operation is skipping the reception of any downlink transmission that at least partially overlaps with the DTX/μDTX period/occasions. This is equally applicable for any uplink transmissions from the UE to the base station, which are also skipped. In these examples, the ‘skipping’ performed by the UE means that the operation (or operations) associated with the reception/transmission are not performed, or are ignored by the UE.

In examples, the UE may apply skipping of at least one of: PDSCH reception, PDSCH aggregation factor adaptation, PDCCH monitoring skipping, radio resource management (RRM)/radio link monitoring (RLM)/bidirectional forwarding detection (BFD)/level 1 reference signal received power (L1-RSRP) measurement adaptation, uplink transmission skipping, and/or other operations for different channels/signals colliding with a DTX/μDTX occasion.

The first and second parts of the provided mechanism are described in more detail below.

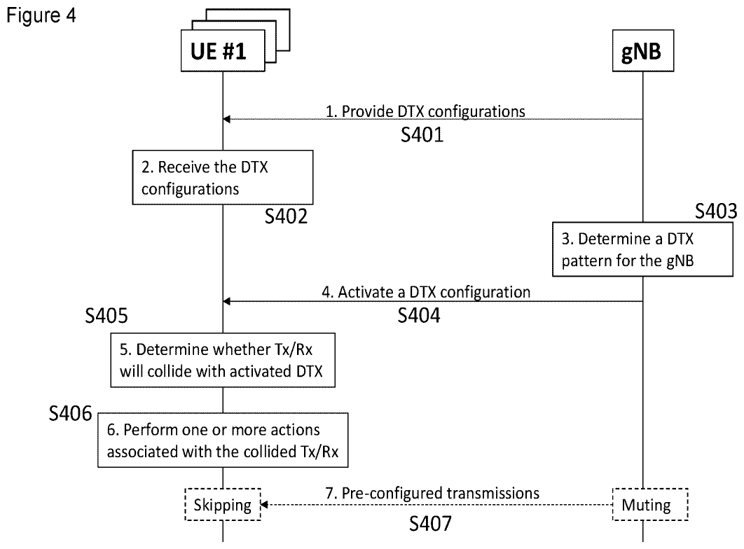

FIG. 4 shows an example signalling diagram between a terminal and a network entity. In the example of FIG. 4, the terminal is a user equipment, and the network entity is a gNB. In other examples, the terminal and network entity may be other suitable devices.

In S401, the gNB determines one or more DTX configurations to be used by the gNB. The gNB may identify the one or more DTX configurations. Instead, the gNB may receive the one or more DTX configurations from another network entity. Each DTX configuration of the one or more DTX configurations comprises at least one time period associated with the DTX configuration. The at least one time period may indicate a time period while the gNB is in sleep mode, i.e. no transmissions being performed. Each DTX configurations of the gNB may comprise a plurality of time periods, wherein the gNB is in ‘sleep’ mode during each time period.

The gNB provides the one or more DTX configurations to the UE. In examples, the gNB provides a plurality of DTX configurations to the UE. The gNB may use RRC signalling to provide the DTX configurations to the UE. In other examples, other suitable signalling is used, such as system information.

When there are a plurality of UEs within coverage of a cell provided by the gNB, the gNB may broadcast the one or more DTX configurations to all, or a subset, of UEs within the cell.

In S402, the UE receives the one or more DTX configurations. The one or more DTX configurations may be stored locally at the UE. In other examples, the one or more DTX configurations are stored at another suitable location. Once received, the one or more DTX configurations are accessible to the UE.

In S403, the gNB determines a DTX configuration of the one or more DTX configurations to use. The gNB may identify the DTX configuration to use. In other examples, the gNB may receive an indication of a DTX configuration to use from another network entity. The step of S403 may comprise the gNB selecting a cell DTX configuration.

In S404, the gNB provides an indication to the UE with a DTX configuration. The indicated DTX configuration is the DTX configuration that the gNB is currently using, or about to use. When the UE has been provided with a plurality of DTX configurations in S401, the indication may comprise a selection of one of the plurality of DTX configurations to activate at the UE.

The indication indicates, to the terminal, that the network entity will refrain from performing downlink transmissions during one or more time periods (i.e. sleep periods) of the discontinuous transmission configuration.

In some examples, steps S401, and S404 are replaced with a single transmission from the gNB the UE. This single transmission comprising an indication of a DTX configuration that the gNB is using, or scheduled to use.

In some examples, there is dual-level indication of the DTX configuration to the UE. In these examples, each level of the dual-level may be indicated in the same signalling or in separate signalling.

The first level is the initial indication of the DTX configuration to the UE. The DTX configuration may comprise one or more time periods (e.g. sleep periods). This may be referred to as a DTX pattern of the DTX configuration.

The second level is an indication of when the DTX pattern of the DTX configuration is active. For example, this may be a time period from when the gNB starts to apply DTX till when the gNB stops applying the DTX. For example, the gNB applies the DTX pattern (first level) with an interval of [10 ms, 1000 ms] (second level).

The information of the first and second levels may be indicated to the UE in a plurality of different ways. For example, a first alternative uses RRC signalling (which indicates the DTX pattern) to activate and deactivate the DTX pattern. A second alternative uses the GC-PDCCH to activate and deactivate the DTX pattern. A third alternative uses GC-PDCCH or RRC to provide an availability duration of the DTX pattern. For example, the GC-PDCCH indicates that the DTX pattern will be activated in the following 100 ms time period. It should be understood that these alternatives are provided as examples to aid in the understanding of the invention. In other examples, other suitable signalling is used.

In S405, the UE determines whether a reception of a message at the terminal (i.e. DL transmission), and/or a transmission of a message from the terminal (i.e. UL transmission), will at least partially overlap with a time period associated with the activated DTX configuration. The DL or UL transmission may be scheduled, or pre-configured, in some examples. Examples of pre-configured transmissions include CSI-RS transmissions, and DL SPS transmissions.

The UE may compare the timings of any scheduled receptions or transmissions from the UE with the time period associated with the DTX configuration being used by the gNB. When the UE determines that there will be a partial overlap, or a full overlap, then the UE knows that there will be a collision between the scheduled communications and the sleep period of the gNB.

In S406, in response to determining that a reception and/or transmission will at least partially overlap/collide with the time period of the DTX configuration, the UE will perform one or more actions associated with the reception and/or transmission that has been determined. The UE may perform a variety of different actions when the overlap has been determined. The action performed may depend on, for example, the type of reception/transmission, or the type of data.

In some examples, a default action to be performed by the UE is a skipping of the determined reception and/or transmission that overlaps with the time period of the DTX configuration. The ‘skipping’ performed by the UE means that the UE refrains from performing the operation (or operations) associated with the reception/transmission.

In S407, the gNB is scheduled (pre-configured) to perform a DL transmission to the UE while the gNB is in a sleep period of the currently used DTX configuration. The DL transmission is muted at the gNB. In this way, the gNB refrains from providing the DL transmission to the UE.

As the UE has determined that the DL transmission of the gNB will at least partially overlap the time period of the DTX configuration, the UE skips the reception of the DL transmission from the gNB. For example, the UE may not look to detect the DL transmission in the scheduled slot. For example, the UE may not look to decode and/or measure the DL transmission in the scheduled slot.

It should be understood that the action of skipping, performed by the UE, is an example only. In other examples, the UE may perform one or more of the following actions.

In examples, the UE may determine that a scheduled DL SPS will overlap with the time period of the DTX configuration. In this case, the gNB may provide one or more instructions to the UE to instruct the UE whether to receive the DL SPS. The one or more instructions may be provided within the DTX configuration. In other examples, the one or more instructions are provided in a separate message.

The one or more instructions received at the UE may result in configurations which leads the UE to behave in the following ways.

In an example, the action of the UE is to refrain from receiving SPS PDSCHs, which are at least partially overlapped with the time period of the DTX configuration. The UE may treat overlapped/colliding SPS PDSCH occasions as invalid, and will refrain from performing any receiving actions or to provide A/N feedback.

In an example, the action of the UE is to still receive the SPS PDSCH, even though there is at least a partial overlap.

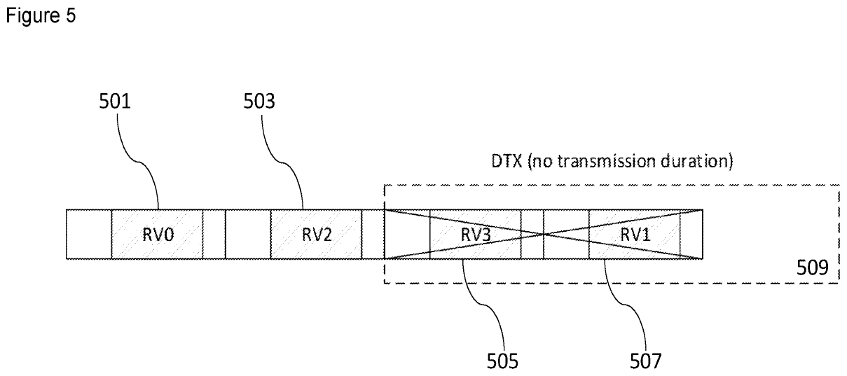

In an example, when PDSCH aggregation is applied by the network, some of the PDSCHs overlapped with DTX occasions may be skipped by the UE. When a first redundant version #0, RV0, is overlapped with DTX, then the action of the UE is that all RVs are skipped by the UE. When RVs other than RV0 are overlapped with DTX, then the action of the UE is that the UE shall consider the aggregated PDSCHs as valid and then adjust the aggregation level accordingly. This is illustrated in FIG. 5.

FIG. 5 shows a schematic example of aggregation level adjustment for a physical downlink shared channel. PDSCH aggregation factor is a mechanism that one downlink control information (DCI) may schedule multiple consecutive downlink slots for PDSCH. According to current standards, the number of the consecutive slots may be 2 or 4 or 8. The number of slots may be determined by the RRC parameter ‘pdsch-AggregationFactor’.

In the example of FIG. 5 there are 4 consecutive slots of redundant versions, labelled RV0 501, RV2 503, RV3 505 and RV1 507. However, redundant versions RV3 505 and RV1 507 are overlapped with a time period 509 of DTX being performed at a base station. The UE will determine this overlapping of RV3 505 and RV1 507. In this case, the UE considers the aggregated PDSCHs RV0 501 and RV2 503 as valid and adjusts the aggregation level to 2. In this way, the UE does not perform actions to receive the redundant version RV3 505 and RV1 507.

In examples, the UE may determine that semi-persistent references signals, or periodic reference signal (RS), to be received, will overlap with the time period of the DTX configurations. In this case, the UE may perform measurements on REs, of the reference signals, that do not fully overlap with the DTX configuration. In other examples, the UE may perform measurements on REs, of the reference signals, that do not at least partially overlap with the DTX configuration. Examples of measurements, performed by the terminal, include reference signal received power (RSRP), reference signal received quality (RSRQ), received signal strength indicator (RSSI), radio resource management (RRM) related measurements, and beamforming related measurements.

In examples, omitting (or skipping) a given measurement entails skipping the reception of the channels/signals (e.g. a reference signal) for deriving the associated measurement sample.

In examples, the UE may determine that a system information block (SIB) or synchronization signal block (SSB), to be received, will overlap with the time period of the DTX configuration. In this case, the UE may follow an indication/instruction comprised within the received DTX configuration from the network entity to determine whether to receive the SSB/SIB or not. In some examples, the indication in the DTX configuration will configure the UE to receive the SSB/SIB, even when there is an overlap. In other examples, the indication in the DTX configuration will configure the UE to refrain from receiving the SSB/SIB when there is an overlap.

In examples, the UE may determine that a reception on a physical downlink control channel (PDCCH), to be received, will overlap with the time period of the DTX configuration. In this case, when the UE's own discontinuous reception (DRX) active time collides with the time period of the DTX configuration, then the UE may skip the PDCCH monitoring occasions that are colliding with the DTX period time. In examples, the skipping is confined to a certain search space set group (or groups). In other examples, the skipping is applied to any search space. The search space is related to where the UE receives different control information from the gNB. The gNB may indicate multiple search space configurations to a UE. In examples, when the UE receives a DTX configuration for the gNB, from the gNB, the DTX configuration may indicate certain search spaces to skip, or an indication to skip all of the search spaces.

In the case of a reception on the PDCCH, the UE may not be able to receive HARQ feedback (i.e. new data indication, NDI) if UE is not monitoring the PDCCH. If the network activates the DTX, and the UE is expecting HARQ feedback on UL data previously transmitted, then the UE can assume that the feedback NDI is postponed, in some examples. In other examples, the UE assumes an implicit ACK.

In examples, in order to save additional energy the gNB receiver may also at least partially power down. Therefore, uplink transmissions, from the UE to the gNB, may also be stopped/postponed. In examples, the UE may determine that a scheduled UL transmission will at least partially overlap with the time period of the DTX configuration. In this case, the UE may skip/stop any UL transmissions fully overlapped with the DTX time period. In this case, the UE may skip/stop any UL transmissions that partially overlapped with the DTX time period.

When a UE has previously received downlink data and is to provide HARQ feedback, the UE may skip the PUCCH transmission comprising the feedback if the PUCCH transmission will overlap with the DTX time period, in some examples. In other examples, the UE may postpone providing the feedback in a PUCCH transmission until the DTX is not active at the network.

In examples, one or more UE timers may be impacted by the configurations of DTX/μDTX used at the gNB. For example, for a UE's DRX inactivity timer, the UE may suspend the timer. In other examples, the UE may let the timer expire. In other examples, the UE may prolong the timer. The UE's DRX timers related to retransmission may be adjusted in a similar manner. The actions performed by the UE, related to the timers, may depend on configuration indications/instructions that are comprised within the DTX configuration.

It should be understood that configurations for μDTX are equally applicable in the examples of FIG. 4. The DTX and μDTX configurations can be used interchangeably, or together.

In the above example of FIG. 4, the DTX or μDTX pattern indication is on a millisecond (ms) level (i.e. time). In other examples, the patterns of the DTX/μDTX configuration are on a symbol, a slot, or a subframe level.

An example configuration for a μDTX is shown below. It should be understood that a similar configuration may be provided for a DTX configuration. The DTX/μDTX may comprise one or more indications or instructions for the UE, to configure the behaviour of the UE when certain signals, certain channels, etc. are received at the UE.

| | |
|---|---|
| uDTXConfig ::= | SEQUENCE { |
| patternOffset | INTEGER (0..39), |
| DTXlength | ENUMERATED {ms1, ms2, ms3, ms4, ms5, ms6, ms7, ms8, ms9, ms10}, |
| DTXrepetition | ENUMERATED {ms5, ms10, ms20, ms40}, |
| UEoperation | ENUMERATED {default, special}, |
| DL_SPS | ENUMERATED {Receive, skip, aggregation_adapt}, |
| DL_HARQfeedback | ENUMERATED {postpone, ACK}, |
| UL_HARQfeedback | ENUMERATED {postpone, NACK}, |
| SSB/SIB | ENUMERATED {drop, receive}, |

...,
}

The field of “patternOffset” indicates the offset of the μDTX pattern within DTX repetition period. The field of “DTXlength” is a length of time with no transmissions (i.e. a no transmission period). The field of “DTXrepetition” is the repetition period of μDTX pattern. The field of “UEoperation” indicates a UE operation in μDTX, for example, as a default—skipping/dropping all DL transmissions in DTXlength, or apply special operations on different channels/signals in DTXlength. The field of “DL_SPS” indicates special operations UE shall apply for DL SPS occasions partially overlapped with DTXlength. The field of “DL_HARQfeedback” indicates UE operations to be performed when DL HARQ feedback overlapped with DTXlength. The field of “UL_HARQfeedback” indicates UE operations when UL HARQ feedback occasion overlapped with DTXlength.

In examples, the DTX/μDTX configurations provided to the UE (e.g. in S401 and S404) may comprise one or more of the fields described above. In some examples, the DTX/μDTX configurations comprise a subset of the fields described above.

One or more of the examples presented above allow network energy and resources to be saved, through the use of DTX and/or μDTX one the network side.

However, when transmissions by the base stations are skipped, or delayed, then there may be an impact on UEs that are within coverage of the cell provided by the base station.

For example, a UE in coverage may assume that DL SPS will be transmitted by the base station (if it is activated). In this case, the UE would perform reception operations on the DL SPS occasions. The UE may also report a negative acknowledgement (NACK) if the DL SPS occasion was not received. If reception occasions overlap with a DTX time period of the base station, then the UE may consume additional power and may lead to hybrid automatic repeat request (HARQ) codebook misunderstanding.

Furthermore, a UE may assume a DL reference signal RS resource is to be used, unaware that the RS has be muted by the cell. In this case, the UE may still perform requested measurements on this DL RS resource. The measurement outcome by the UE may corrupt the associated measurement averaging. This may also reduce the accuracy and usefulness of the measurement reports for the network. Furthermore, this may result in, for example, an incorrect detection of radio link failure (RLF), and/or beam failure.

One or more of the examples above address these issues, by providing a mechanism whereby the UE is provided with information that allows the UE to determine when/where the gNB applies DTX. This is beneficial as the associated UE behaviours can be changed such that network resources are used efficiently. Furthermore, in the examples whereby all UEs within cell coverage are indicated of the DTX/μDTX configuration via broadcast, this further saves network resources when compared to UE-specific indications and/or channel-specific indications.

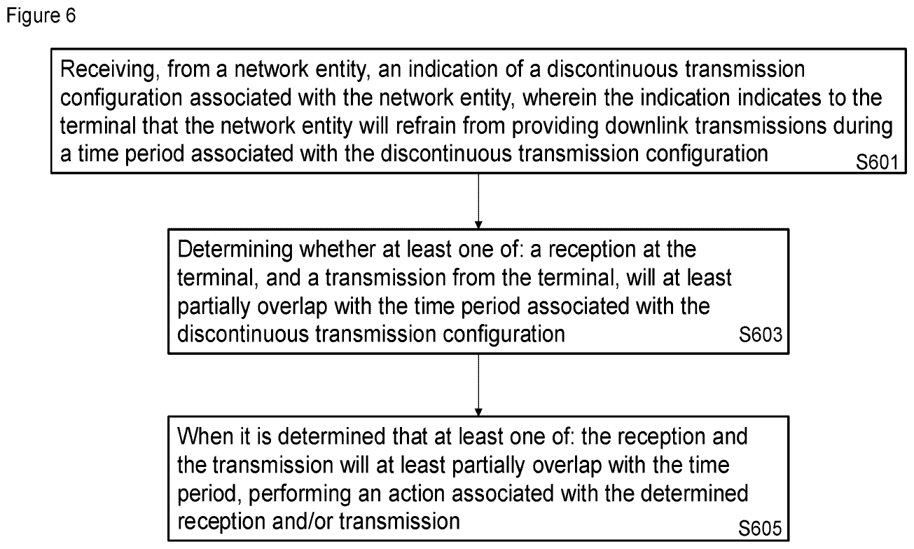

FIG. 6 shows an example method flow performed by an apparatus. The apparatus may be comprised within a terminal. The apparatus may be comprised within a user equipment.

In S601, the method comprises receiving, from a network entity, an indication of a discontinuous transmission configuration associated with the network entity, wherein the indication indicates to the terminal that the network entity will refrain from providing downlink transmissions during a time period associated with the discontinuous transmission configuration.

In S603, the method comprises determining whether at least one of: a reception at the terminal, and a transmission from the terminal, will at least partially overlap with the time period associated with the discontinuous transmission configuration.

In S605, the method comprises, when it is determined that at least one of: the reception and the transmission will at least partially overlap with the time period, performing an action associated with the determined reception and/or transmission.

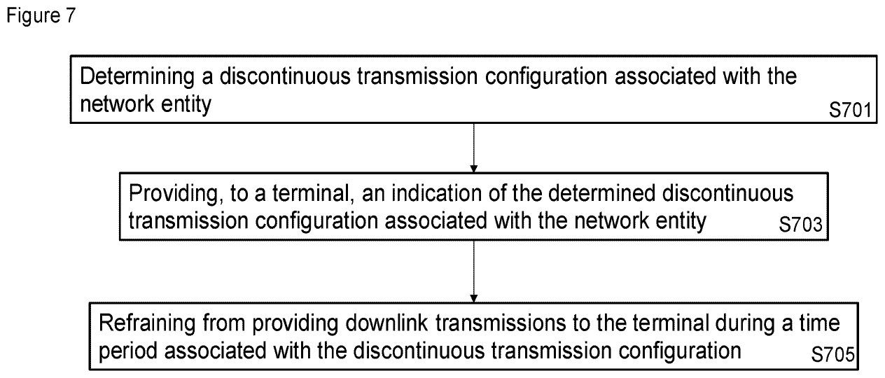

FIG. 7 shows an example method flow performed by an apparatus. The apparatus may be comprised within a network entity. In an example, the network entity is a base station. In an example, the network entity is a gNB. In an example, the network entity is a core network entity.

In S701, the method comprises determining a discontinuous transmission configuration associated with the network entity.

In S703, the method comprises providing, to a terminal, an indication of the determined discontinuous transmission configuration associated with the network entity.

In S705, the method comprises refraining from providing downlink transmissions to the terminal during a time period associated with the discontinuous transmission configuration.

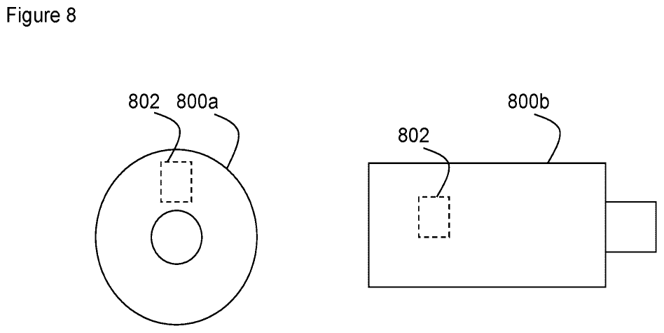

FIG. 8 shows a schematic representation of non-volatile memory media 800a (e.g. computer disc (CD) or digital versatile disc (DVD)) and 800b (e.g. universal serial bus (USB) memory stick) storing instructions and/or parameters 802 which when executed by a processor allow the processor to perform one or more of the steps of the methods of FIG. 6 or FIG. 7.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1-61. (canceled)

62. An apparatus for a terminal, the apparatus comprising:
at least one processor; and
at least one memory storing instructions that, when executed with the at least one processor, cause the apparatus to perform:
receiving, from a network entity, an indication of a discontinuous transmission configuration associated with the network entity, wherein the indication indicates to the terminal that the network entity will refrain from providing downlink transmissions during a time period associated with the discontinuous transmission configuration;
determining whether at least one of: a reception at the terminal or a transmission from the terminal will at least partially overlap with the time period associated with the discontinuous transmission configuration; and
when it is determined that at least one of: the reception or the transmission will at least partially overlap with the time period, performing an action associated with the determined at least one of the reception or the transmission.

63. The apparatus according to claim 62, wherein the instructions, when executed with the at least one processor, cause the apparatus to perform applying a skipping of the determined at least one of the reception or the transmission, such that the terminal refrains from performing operations associated with the determined at least one of the reception or the transmission.

64. The apparatus according to claim 62, wherein the instructions, when executed with the at least one processor, cause the apparatus to perform skipping measurements to be performed with the terminal, when the determined reception at the terminal comprises at least one reference signal.

65. The apparatus according to claim 62, wherein the instructions, when executed with the at least one processor, cause the apparatus to perform performing measurements on reference signal resource elements that do not overlap with the time period associated with the discontinuous transmission configuration.

66. The apparatus according to claim 62, wherein the instructions, when executed with the at least one processor, cause the apparatus to perform postponing at least one of a reception or a transmission operation associated with the determined at least one of the reception or the transmission.

67. The apparatus according to claim 62, wherein the instructions, when executed with the at least one processor, cause the apparatus to perform changing a timer associated with the determined at least one of the reception or the transmission.

68. The apparatus according to claim 67, wherein the changing the timer comprises at least one of: suspending the timer, ignoring an expired timer, or extending a timer.

69. The apparatus according to claim 62, wherein the discontinuous transmission configuration comprises a resource pattern, in the time domain, wherein the resource pattern comprises at least one of: a pattern time duration, a time offset, a repetition period, or a micro-discontinuous transmission configuration.

70. The apparatus according to claim 69, wherein the resource pattern comprises at least one of: information about the applicability of the resource pattern to at least one of one or more channels or signals, and operations to be performed with the terminal related to the at least one of the one or more channels or signals.

71. The apparatus according to claim 62, wherein the indication is received, with a broadcast signalling, to terminals in a cell, wherein the terminal is within coverage of the cell, the cell being provided with the network entity.

72. The apparatus according to claim 62, wherein the instructions, when executed with the at least one processor, cause the apparatus to perform:
receiving a plurality of discontinuous transmission configurations associated with the network entity,
wherein the discontinuous transmission configuration is one of the plurality of discontinuous transmission configurations.

73. The apparatus according to claim 72, wherein the plurality of discontinuous transmission configurations is received with: radio resource signalling, a medium access control control element, downlink control information, or system information.

74. The apparatus according to claim 62, wherein the instructions, when executed with the at least one processor, cause the apparatus to perform: receiving, from the network entity, an indication to activate the discontinuous transmission configuration.

75. The apparatus according to claim 62, wherein the instructions, when executed with the at least one processor, cause the apparatus to perform:
wherein physical downlink shared channel aggregation is configured for the terminal with the network entity, determining whether a first redundant version of the determined reception is at least partially overlapped with the time period associated with the discontinuous transmission configuration; and
when is it determined that the first redundant version is at least partially overlapped, skipping the reception of all redundant versions associated with the determined reception.

76. The apparatus according to claim 62, wherein the instructions, when executed with the at least one processor, cause the apparatus to perform:
wherein physical downlink shared channel aggregation is applied with the network entity, determining whether at least one redundant version other than the first redundant version of the determined reception is overlapped with the time period associated with the discontinuous transmission configuration; and
when is it determined that at least one redundant version other than the first redundant version is overlapped, adjusting an aggregation level associated with the determined reception.

77. The apparatus according to claim 62, wherein the instructions, when executed with the at least one processor, cause the apparatus to perform:
receiving, from a network entity, a further indication of a discontinuous reception configuration associated with the terminal.

78. The apparatus according to claim 77, wherein the instructions, when executed with the at least one processor, cause the apparatus to perform:
determining whether a transmission from the terminal will at least partially overlap with a further time period associated with the discontinuous reception configuration; and
when it is determined that the transmission will at least partially overlap with the further time period, performing a further action associated with the determined at least one reception or transmission.

79. An apparatus for a network entity, the apparatus comprising:
at least one processor; and
at least one memory storing instructions that, when executed with the at least one processor, cause the apparatus to perform:
determining a discontinuous transmission configuration associated with the network entity;
providing, to a terminal, an indication of the determined discontinuous transmission configuration associated with the network entity; and
refraining from providing downlink transmissions to the terminal during a time period associated with the discontinuous transmission configuration.

80. The apparatus according to claim 79, wherein the discontinuous transmission configuration associated with the network entity is: being used with the network entity, or is scheduled to be used with the network entity.

81. A method performed with a terminal, the method comprising:
receiving, from a network entity, an indication of a discontinuous transmission configuration associated with the network entity, wherein the indication indicates to the terminal that the network entity will refrain from providing downlink transmissions during a time period associated with the discontinuous transmission configuration;
determining whether at least one of: a reception at the terminal or a transmission from the terminal will at least partially overlap with the time period associated with the discontinuous transmission configuration; and
when it is determined that at least one of: the reception or the transmission will at least partially overlap with the time period, performing an action associated with the determined at least one of the reception or the transmission.
